(19) United States
(12) Patent Application Publication
(10) Pub. No.: US 2026/0238055 A1
(43) Pub. Date: Aug. 13, 2026

(54) ROTARY ELECTRIC MACHINE AND ROTARY ELECTRIC MACHINE UNIT

(71) Applicant: Mitsubishi Electric Mobility Corporation, Tokyo (JP)

(72) Inventors: Kenji KATO, Tokyo (JP); Keisuke TAKEISHI, Tokyo (JP); Kengo KUMAGAI, Tokyo (JP); Masatsugu NAKANO, Tokyo (JP); Takeshi KUBOTA, Tokyo (JP); Shinsuke KAYANO, Tokyo (JP)

(73) Assignee: Mitsubishi Electric Mobility Corporation, Tokyo (JP)

(21) Appl. No.: 19/155,620

(22) PCT Filed: May 12, 2023
(86) PCT No.: PCT/JP2023/017845

§ 371 Date: Aug. 12, 2025

(51) Int. Cl. H02K 1/32; H02K 7/00; H02K 9/19

(52) U.S. Cl. CPC H02K 1/32; H02K 7/003; H02K 9/19

(57) ABSTRACT

A rotary electric machine includes: a rotary shaft; a rotor fixed to an outer circumference of the rotary shaft and having a magnet; and a stator provided on an outer-circumferential side of the rotor. The magnet extends from a one-end side to an other-end side in an axial direction of the rotor. The rotor includes a first channel and a second channel which extend from the one-end side to the other-end side in the axial direction of the rotor and through which a coolant flows. At least one of the first channel or the second channel is formed along the magnet. Directions of the coolant flowing in the axial direction are opposite to each other between the first channel and the second channel.

### TECHNICAL FIELD

The present disclosure relates to a rotary electric machine and a rotary electric machine unit.

### BACKGROUND ART

A conventional rotary electric machine has a rotor, and a stator provided on the outer side or the axial-direction side of the rotor, and a rotor magnet generates heat, so that the temperature of a rotor magnet increases.

When the temperature of the rotor magnet increases, the rotor magnet is demagnetized, resulting in a fault. Therefore, the temperature of the rotor magnet needs to be decreased.

Accordingly, a cooling channel structure for cooling the rotor magnet may be provided inside the rotor, and a coolant flows through the cooling channel, thus improving cooling performance for the rotor magnet (see, for example, Patent Document 1).

### CITATION LIST

### Patent Document

Patent Document 1: Japanese Laid-Open Patent Publication No. 2022-107336

### SUMMARY OF THE INVENTION

### Problem to be Solved by the Invention

In such a rotary electric machine and a rotary electric machine unit in conventional art, a plurality of cooling channels are all formed to branch from the center in the axial direction of the rotor. Thus, flows in the cooling channels become the same, so that the rotor cannot be efficiently cooled and the temperature distribution in the rotor becomes uneven.

The present disclosure has been made to solve the above problem, and an object of the present disclosure is to provide a rotary electric machine and a rotary electric machine unit in which a rotor can be efficiently cooled and the temperature distribution in the rotor can be uniformed.

### Means to Solve the Problem

A rotary electric machine according to the present disclosure includes: a rotary shaft; a rotor fixed to an outer circumference of the rotary shaft and having a magnet; and a stator provided on an outer-circumferential side of the rotor. The magnet is formed to extend from a one-end side to an other-end side in an axial direction of the rotor. The rotor includes a first channel and a second channel which extend from the one-end side to the other-end side in the axial direction of the rotor and through which a coolant flows. At least one of the first channel or the second channel is formed along the magnet. Directions of the coolant flowing in the axial direction are opposite to each other between the first channel and the second channel,

In a rotary electric machine unit according to the present disclosure, a gear is connected to a rotary shaft of a rotary electric machine including: a rotary shaft; a rotor fixed to an outer circumference of the rotary shaft and having a magnet; and a stator provided on an outer-circumferential side of the rotor. The magnet is formed to extend from a one-end side to an other-end side in an axial direction of the rotor. The rotor includes a first channel and a second channel which extend from the one-end side to the other-end side in the axial direction of the rotor and through which a coolant flows. At least one of the first channel or the second channel is formed along the magnet. Directions of the coolant flowing in the axial direction are opposite to each other between the first channel and the second channel. The rotary shaft includes an in-shaft channel through which the coolant flows and which extends at a position corresponding to a range from the one-end side to the other-end side in the axial direction of the rotor in the rotary shaft, a first communication channel communicating from a one-end side in the axial direction of the in-shaft channel to the first channel, and a second communication channel communicating from the other-end side in the axial direction of the in-shaft channel to the second channel. The gear is provided on the other-end side in the axial direction opposite to the one-end side in the axial direction where the coolant is introduced into the in-shaft channel.

### Effect of the Invention

With the rotary electric machine and the rotary electric machine unit according to the present disclosure, it becomes possible to efficiently cool a rotor and uniform the temperature distribution in the rotor.

### BRIEF DESCRIPTION OF THE DRAWINGS

FIG. 1 is a sectional view showing a configuration of a rotary electric machine according to embodiment 1.

FIG. 2 is an enlarged sectional view of a part of the rotary electric machine shown in FIG. 1.

FIG. 3 is a sectional view showing a part of another configuration of the rotary electric machine according to embodiment 1.

FIG. 4 is a sectional view showing a configuration of a rotary electric machine according to embodiment 2.

FIG. 5 is an enlarged sectional view of a part of the rotary electric machine shown in FIG. 4.

FIG. 6 is a sectional view showing a configuration of a rotary electric machine according to embodiment 3.

FIG. 7 is a plan view showing a configuration of a rotor of the rotary electric machine shown in FIG. 6.

FIG. 8 is a plan view showing a configuration of an end plate on a one-end side in the axial direction of the rotor of the rotary electric machine shown in FIG. 6.

FIG. 9 is a plan view showing a configuration of an end plate on the other-end side in the axial direction of the rotor of the rotary electric machine shown in FIG. 6.

FIG. 10 is a sectional view showing another configuration of the rotor of the rotary electric machine according to embodiment 3.

FIG. 11 is a plan view showing a configuration of a rotor of a rotary electric machine according to embodiment 4.

FIG. 12 is a plan view showing another configuration of the rotor of the rotary electric machine according to embodiment 4.

FIG. 13 is a plan view showing a configuration of a rotor of a rotary electric machine according to embodiment 5.

FIG. 14 is a plan view showing another configuration of the rotor of the rotary electric machine according to embodiment 5.

FIG. 15 is a plan view showing another configuration of the rotor of the rotary electric machine according to embodiment 5.

FIG. 16 is a plan view showing a configuration of an end plate on a one-end side in the axial direction of the rotor of the rotary electric machine according to embodiment 6.

FIG. 17 is a plan view showing another configuration of the end plate on the one-end side in the axial direction of the rotor of the rotary electric machine according to embodiment 6.

FIG. 18 is a sectional view showing a configuration of a rotor of a rotary electric machine according to embodiment 7.

FIG. 19 is a plan view showing a configuration of an end plate on the other-end side in the axial direction of the rotor of the rotary electric machine shown in FIG. 18.

FIG. 20 is a sectional view showing a configuration of a rotary electric machine unit according to embodiment 8.

### DESCRIPTION OF EMBODIMENTS

In the following description, directions about the rotary electric machine 1 are described as a circumferential direction Z, an axial direction Y, a one-end side Y1 in the axial direction Y, an other-end side Y2 in the axial direction Y, a radial direction X, an outer side X1 in the radial direction X, and an inner side X2 in the radial direction X. Therefore, these directions are applied in the same manner for a stator 5, a rotor 4, and other parts, and directions are described using the above directions as references. In the present disclosure, all “channels” are cooling channels through which a coolant passes, and description thereof is omitted as appropriate.

The rotary electric machine 1 is used in internal combustion engines such as a gasoline engine and a diesel engine, a hybrid vehicle or an electric vehicle using, as a motive power source, a motor supplied with power from a chargeable/dischargeable secondary battery, an air conditioner, an industrial motor, or a railroad vehicle, for example. The rotary electric machine 1 has at least one of a function as a motor for generating a drive force by being supplied with power or a function as an electric generator.

### Embodiment 1

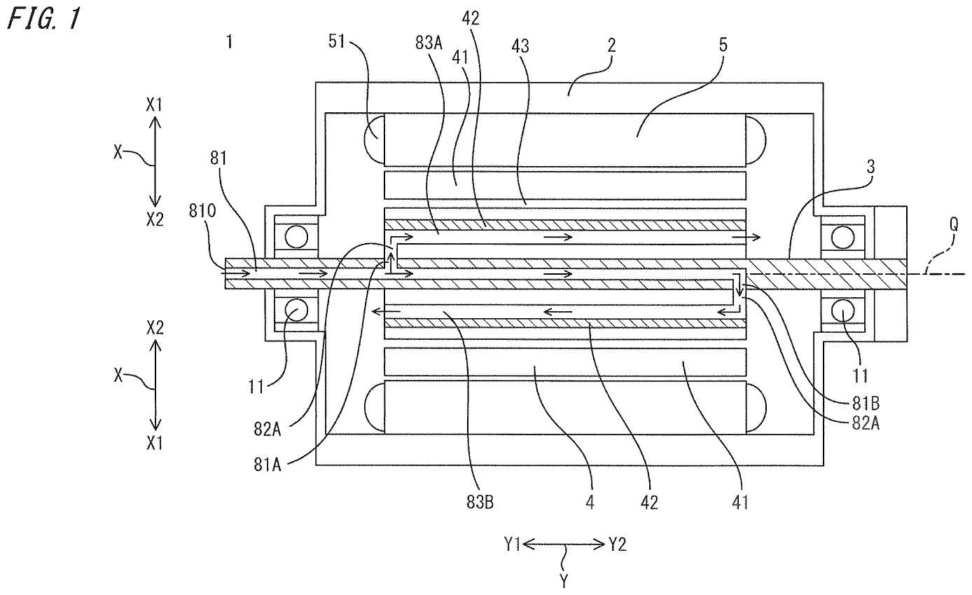

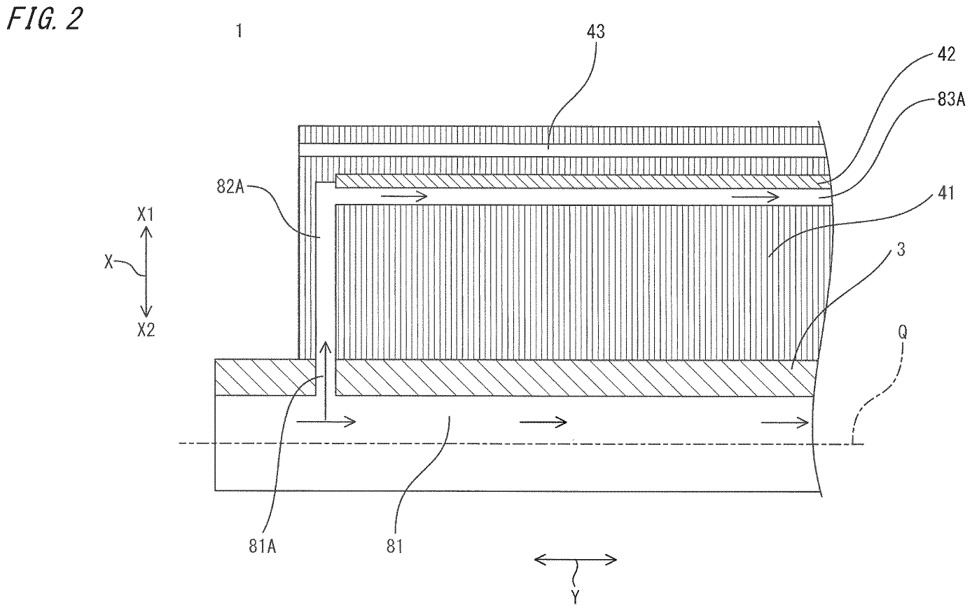

FIG. 1 is a sectional view showing a configuration of a rotary electric machine according to embodiment 1. FIG. 2 is an enlarged sectional view of a part of a rotary electric machine shown in FIG. 1.

As shown in FIG. 1, the rotary electric machine 1 includes a housing 2, a rotary shaft 3 formed to penetrate through the housing 2, the rotor 4 provided around the outer circumference of the rotary shaft 3 and fixed to the rotary shaft 3, and the stator 5 provided around the outer circumference of the rotor 4. The rotary shaft 3 extends in the axial direction Y along a center axis Q of rotation, is supported via bearings 11 by the housing 2, and is provided rotatably about the center axis Q.

The rotor 4 includes a rotor core 41, a permanent magnet (hereinafter, referred to as a magnet) 42 buried in the rotor core 41, and a flux barrier 43. The magnet 42 is formed to extend from the one-end side Y1 toward the other~end side Y2 in the axial direction Y of the rotor 4. That is, the rotary electric machine 1 of the present embodiment 1 is an IPM motor (Interior Permanent Magnet Motor), as an example. However, without limitation thereto, the rotary electric machine 1 may be a SPM motor (Surface Permanent Magnet Motor) with a plurality of magnets attached to the outer-circumferential surface of the rotor core.

The rotor core 41 has a cylindrical shape and is formed by a plurality of electromagnetic steel sheets stacked in the axial direction Y. The rotor core 41 is provided around the outer-circumferential surface of the rotary shaft 3 by fitting, press-fit, shrink-fit, or the like. The rotor 4 and the rotary shaft 3 are fitted together in a key shape, and the rotor 4 and the rotary shaft 3 are formed to be integrally rotatable. The flux barrier 43 is a hole provided for preventing a magnetic flux extending from the magnet 42 from leaking to the outer-circumferential surface of the rotor 4 or a hole provided for preventing stress concentration in the rotor 4, and is filled with air, a resin, a nonmagnetic material, or the like.

The stator 5 is provided around the outer circumference of the rotor 4, and includes a stator core and a coil 51 wound at the stator core. The stator core is formed by a plurality of electromagnetic steel sheets stacked in the axial direction Y. Each of the stator core and the rotor core 41 may be integrally formed by a dust core, instead of electromagnetic steel sheets. The stator 5 has a plurality of coils 51 with gaps therebetween in the circumferential direction Z. When the coils 51 are energized, a rotating magnetic field is generated around the stator 5, and the rotary shaft 3 and the rotor 4 integrally rotate relative to the housing 2 and the stator 5, due to an action of the rotating magnetic field. The housing 2 has a bottomed-cylindrical shape, houses the rotor 4 and the stator 5, and rotatably supports the rotary shaft 3 via a pair of bearings 11.

Next, cooling channels through which a coolant flows for cooling the rotor 4 will be described. The coolant is air, water, oil, or another coolant liquid (for heat transfer), for example, and may be any coolant that can cool the rotor 4. The cooling channels include an in-shaft channel 81, a first channel 83A, a second channel 83B, a first communication channel 81A, a second communication channel 81B, and an end channel 82A.

The first channel 83A and the second channel 83B are formed to extend along the magnets 42 from the one-end side Y1 to the other-end side Y2 in the axial direction Y in the rotor 4, and the flows in the axial direction Y of the coolants in the first channel 83A and the second channel 83B are in directions opposite to each other. Here, the first channel 83A is formed to penetrate in the axial direction Y through the rotor 4 on the other-end side Y2 in the axial direction Y. The second channel 83B is formed to penetrate in the axial direction Y through the rotor 4 on the one-end side Y1 in the axial direction Y.

The in-shaft channel 81 is formed to extend in the axial direction Y in the rotary shaft 3 at a position corresponding to a range from the one-end side Y1 to the other-end side Y2 in the axial direction Y of the rotor 4.

Here, for introducing the coolant from outside into the rotary electric machine 1, an inlet 810 is formed on the one-end side Y1 in the axial direction Y of the rotary shaft 3.

Thus, the in-shaft channel 81 extends continuously to the one-end side Y1 in the axial direction Y of the rotary shaft 3. In FIG. 1, the rotary shaft 3 is made partially hollow to form the in-shaft channel 81. However, without limitation thereto, for example, the in-shaft channel may be formed to penetrate in the axial direction Y through the rotary shaft 3.

The first communication channel 81A branches from the in-shaft channel 81 and extends toward the outer side X1 in the radial direction X, on the one-end side Y1 in the axial direction Y of the rotor 4. The second communication channel 81B extends toward the outer side X1 in the radial direction X by bending from the in-shaft channel 81, on the other-end side Y2 in the axial direction Y of the rotor 4.

The end channel 82A is formed in the rotor core 41 while extending toward the outer side X1 in the radial direction X so as to connect the first communication channel 81A and the first channel 83A or connect the second communication channel 81B and the second channel 83B. The end channel 82A may have such a shape as to reduce torque fluctuation and torque ripple in consideration of a Coriolis force.

Next, flow of the coolant in the rotary electric machine 1 of embodiment 1 configured as described above will be described. In FIGS. 1 and 2, flow of the coolant is indicated by arrows. As shown in FIGS. 1 and 2, the coolant is introduced from the inlet 810 of the in-shaft channel 81. Thus, the coolant flows through the in-shaft channel 81 from the one-end side Y1 toward the other-end side Y2 in the axial direction Y. Then, a part of the coolant branches into the first communication channel 81A formed on the one-end side Y1 in the axial direction Y of the in-shaft channel 81, so as to be supplied into the first channel 83A via the end channel 82A.

The supply of the coolant into the first channel 83A is performed as follows: due to an action of centrifugal force generated through rotation of the rotor 4, the coolant introduced into the in-shaft channel 81 flows toward the outer side X1 in the radial direction X and flows into the end channel 82A on the one-end side Y1 in the axial direction Y of the rotor 4. The principle of flow of the coolant from the in-shaft channel 81 into the first channel 83A due to centrifugal force of the rotor 4 is the same also in the other embodiments and therefore description thereof is omitted as appropriate.

In the first channel 83A, the coolant flows from the one-end side Y1 toward the other-end side Y2 in the axial direction Y. Thus, the magnet 42 and the rotor core 41 close to the first channel 83A are efficiently cooled. Then, flow in the axial direction Y of the coolant in the first channel 83A is in the same direction as flow in the axial direction Y of the coolant in the in-shaft channel 81. Then, the coolant is discharged to outside of the rotor 4 from the other-end side Y2 in the axial direction Y of the first channel 83A.

The supply of the coolant of the second channel 83B is performed as follows: due to an action of centrifugal force generated through rotation of the rotor 4, the coolant introduced into the in-shaft channel 81 flows toward the outer side X1 in the radial direction X and flows into the end channel 82A on the other-end side Y2 in the axial direction Y of the rotor 4. The principle of flow of the coolant from the in-shaft channel 81 into the second channel 83B due to centrifugal force of the rotor 4 is the same also in the other embodiments and therefore description thereof is omitted as appropriate.

Another part of the coolant flows to the other-end side Y2 in the axial direction Y in the in-shaft channel 81 without branching into the first communication channel 81A, and flows into the second communication channel 81B on the other-end side Y2 in the axial direction Y of the in-shaft channel 81, so as to be supplied into the second channel 83B via the end channel 82A, Then, flow of the coolant in the axial direction Y in the second channel 83B is in the direction opposite to flow in the axial direction Y of the coolant in the in-shaft channel 81, i.e., the coolant flows from the other-end side Y2 to the one-end side Y1 in the axial direction Y.

Thus, the magnet 42 and the rotor core 41 close to the second channel 83B are efficiently cooled. Then, the coolant is discharged to outside of the rotor 4 from the one end side Y1 in the axial direction Y of the second channel 83B. In this way, the directions of flows in the axial direction Y of coolants in the rotor 4 can be made opposite to each other between the first channel 83A and the second channel 83B, whereby the rotor 4 can be efficiently cooled and the temperature distribution in the rotor 4 can be uniformed. Thus, the maximum temperature of the rotor 4 can be reduced.

Thus, it is possible to solve a problem that the magnet 42 is demagnetized when the temperature of the magnet 42 increases. In addition, the magnet 42 can be efficiently cooled, and owing to temperature reduction in the magnet 42, decrease in the amount of rare earth, efficiency improvement, and output increase of the magnet 42 can be achieved.

The coolant discharged to outside of the rotor 4 may be sent to outside of the rotary electric machine 1 by a pump (not shown), and may be cooled by a radiator, for example. Then, the coolant may be introduced again into the rotary electric machine 1 from the inlet 810. Alternatively, the coolant may circulate in the rotary electric machine 1 while being cooled by a cooler or the like provided in the rotary electric machine 1. Then, the coolant may be introduced again from the inlet 810 via a channel outside the rotary electric machine 1.

As described above, the coolant passes in the rotor 4 through the first channel 83A and the second channel 83B, thereby reducing temperature increase in the magnet 42 buried in the rotor 4. Particularly, in a case where a liquid-state or gas/liquid two-phase-state coolant flows into the rotor 4 from the rotary shaft 3, the coolant is discharged in a gas state to outside of the rotor 4, and by setting the flow volume as appropriate, frictional loss caused by friction of the coolant can be significantly reduced. With this setting, the coolant amount can be adjusted in accordance with the magnet 42 of the rotor 4, and the magnet 42 can be more efficiently cooled.

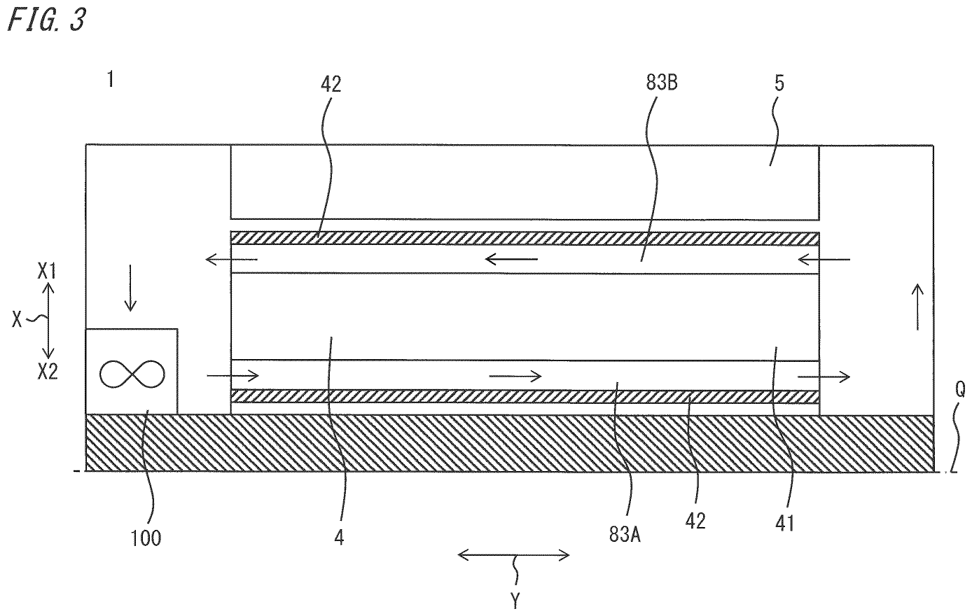

In the above embodiment 1, the in shaft channel 81 is provided and communicates with the first channel 83A and the second channel 83B so that the coolant flows therethrough. However, without limitation thereto, for example, as shown in FIG. 3, only the first channel 83A and the second channel 83B may be provided as coolant channels of the rotor 4, and these channels 83A and 83B may penetrate in the axial direction Y through both of the one-end side Y1 and the other-end side Y2 in the axial direction Y of the rotor 4. Then, a fan 100 may be provided outside the rotor 4, or vanes may be provided at an axial end of the rotor 4. Then, the coolant supplied into the rotary electric machine 1 is caused to flow as indicated by arrows, using the fan 100.

With this configuration, flows of the coolants in the first channel 83A and the second channel 83B can be set in directions opposite to each other in the axial direction Y, as in the above embodiment 1. Thus, the temperature distribution in the rotor 4 can be uniformed.

The rotary electric machine of embodiment 1 configured as described above includes: a rotary shaft; a rotor fixed to an outer circumference of the rotary shaft and having a magnet; and a stator provided on an outer-circumferential side of the rotor. The magnet is formed to extend from a one-end side to an other-end side in an axial direction of the rotor. The rotor includes a first channel and a second channel which extend from the one-end side to the other-end side in the axial direction of the rotor and through which a coolant flows. At least one of the first channel or the second channel is formed along the magnet. Directions of the coolant flowing in the axial direction are opposite to each other between the first channel and the second channel.

Therefore, flows of coolants in the first channel and the second channel can be set in directions opposite to each other in the axial direction, whereby cooling efficiency for the rotor is improved and the temperature distribution in the rotor can be uniformed. As a result, the maximum temperature of the rotary electric machine can be reduced. Thus, size reduction and output increase in the entire rotary electric machine can be achieved.

In the rotary electric machine according to embodiment 1, the rotary shaft includes an in-shaft channel through which the coolant flows and which extends at a position corresponding to a range from the one-end side to the other-end side in the axial direction of the rotor in the rotary shaft, a first communication channel communicating from a one-end side in the axial direction of the in-shaft channel to the first channel, and a second communication channel communicating from the other-end side in the axial direction of the in-shaft channel to the second channel.

Thus, flows of coolants in the first channel and the second channel can be assuredly set in directions opposite to each other in the axial direction.

### Embodiment 2

In the above embodiment 1, the end channels 82A respectively connected to the first channel 83A and the second channel 83B are provided on both end sides in the axial direction Y of the rotor core 41, whereas in the present embodiment 2, a case where an end plate 7A is provided on the one-end side Y1 in the axial direction Y of the rotor core 41 and an end plate 7B is provided on the other-end side Y2, will be described.

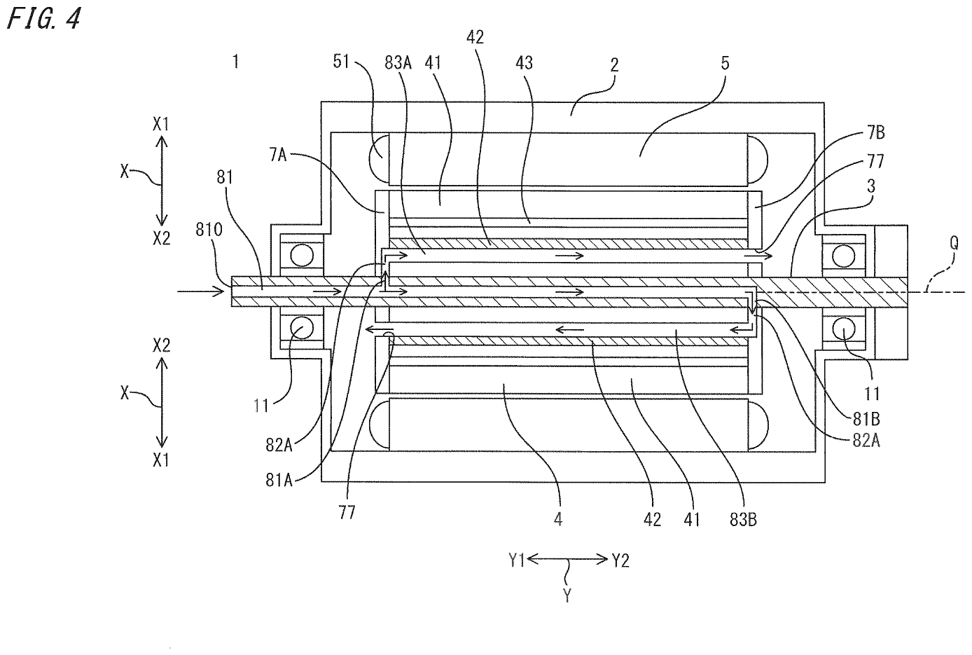

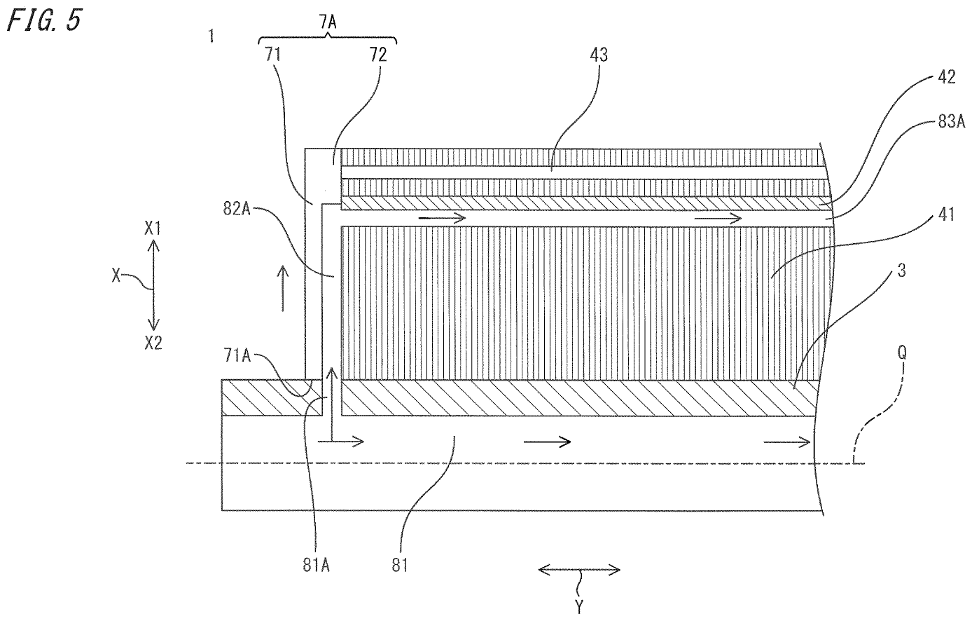

FIG. 4 is a sectional view showing a configuration of a rotary electric machine according to embodiment 2. FIG. 5 is an enlarged sectional view of a part of the rotary electric machine shown in FIG. 4. The same parts as in the above embodiment 1 are denoted by the same reference characters and description thereof is omitted.

As shown in FIG. 4, the end plates 7A and 7B are respectively provided at both ends in the axial direction Y of the rotor 4 so as to be opposed to end surfaces in the axial direction Y of the rotor core 41. The stacking structure of the rotor core 41 using electromagnetic steel sheets in the rotor 4 is held in the axial direction Y between the end plates 7A and 7B. When an end of the rotor core 41 opposed to the magnet 42 is magnetized, due to magnetic force, the rotor core 41 is subjected to force so as to be separated, but since the stacking structure of the rotor core 41 is held between the provided end plates 7A and 7B, the separation is prevented.

The end plates 7A and 7B are fixed to the rotary shaft 3 integrally by means such as screwing or clinching press-fit, and rotates along with rotation of the rotary shaft 3. The end plates 7A and 7B may be formed by electromagnetic steel sheets having a grade different from that of the rotor core 41, for example, or may be formed by a nonmagnetic material. If the end plates 7A and 7B are formed by a nonmagnetic material, they do not interfere with the magnetic circuit.

As shown in FIG. 5, the end plate 7A has an annular-plate portion 71 having a disk shape, and a cylindrical portion 72 protruding toward the rotor core 41 side in the axial direction Y from the outer-circumferential edge of the annular-plate portion 71. The end plate 7A and the end surface on the one-end side Y1 in the axial direction Y of the rotor 4 together form the end channel 82A connecting the first channel 83A and the first communication channel 81A. The end plate 7A further has a hole 77 (see FIG. 4) connecting the second channel 83B and outside. An opening 71A is formed at a center part of the annular-plate portion 71. The rotary shaft 3 is inserted through the opening 71A and thus the annular-plate portion 71 is fixed to the rotary shaft 3, whereby the end plate 7A is fixed to the rotary shaft 3. The annular-plate portion 71 may have, on a surface opposite to the rotor core 41, a fin, a rectangular-shaped protrusion, an arc-shaped protrusion, an S-shaped protrusion, or the like.

The end of the annular shape of the cylindrical portion 72 contacts with the rotor core 41 of the rotor 4, whereby the stacking structure of the rotor core 41 is held in the axial direction Y. The end plate 7B is formed in the same manner, and the end plate 7B and the end surface on the other-end side Y2 in the axial direction Y of the rotor 4 together form the end channel 82A. As described above, the end channels 82A are formed using the end plates 7A and 7B. Thus, as compared to the case where the end channels 82A are formed in the rotor core 41 as in the above embodiment 1, the number of kinds of electromagnetic steel sheets for forming the rotor core 41 decreases, leading to cost reduction.

Next, flow of the coolant in the rotary electric machine 1 of embodiment 2 configured as described above will be described. In FIGS. 4 and 5, flow of the coolant is indicated by arrows. Description of the same parts as in the above embodiment 1 is omitted as appropriate. As shown in FIGS. 4 and 5, the coolant is introduced from the inlet 810 of the in-shaft channel 81, as in the above embodiment 1. Thus, the coolant flows through the in-shaft channel 81 from the one-end side Y1 toward the other-end side Y2 in the axial direction Y.

Then, a part of the coolant branches into the first communication channel 81A formed on the one-end side Y1 in the axial direction Y of the in-shaft channel 81, so as to be supplied into the first channel 83A via the end channel 82A, Therefore, flow in the axial direction Y of the coolant in the first channel 83A is in the same direction as flow in the axial direction Y of the coolant in the in-shaft channel 81. Then, the coolant is discharged to outside of the rotor 4 from the other-end side Y2 in the axial direction Y of the first channel 83A via the hole 77 of the end plate 7B.

Another part of the coolant flows to the other-end side Y2 in the axial direction Y in the in-shaft channel 81 without branching into the first communication channel 81A, and flows into the second communication channel 81B on the other-end side Y2 in the axial direction Y of the in-shaft channel 81, so as to be supplied into the second channel 83B via the end channel 82A. Therefore, flow of the coolant in the axial direction Y in the second channel 83B is in the direction opposite to flow in the axial direction Y of the coolant in the in-shaft channel 81. Then, the coolant is discharged to outside of the rotor 4 via the hole 77 of the end plate 7A from the one-end side Y1 in the axial direction Y of the second channel 83B. In this way, directions of flows in the axial direction of the coolants in the rotor 4 can be made opposite to each other between the first channel 83A and the second channel 83B, whereby the rotor 4 can be efficiently cooled and the temperature distribution in the rotor 4 can be uniformed. Thus, the maximum temperature of the rotor 4 can be reduced.

The rotary electric machine of embodiment 2 configured as described above provides the same effects as in the above embodiment 1, and in addition,
end plates are respectively provided on the one-end side and the other-end side in the axial direction of the rotor, and each end plate and an end surface in the axial direction of the rotor together form an end channel connecting the in-shaft channel and the first channel or the second channel.

Thus, without complicating the configuration of the rotor core, connection between the in-shaft channel, and the first channel and the second channel, can be made using the end plates.

### Embodiment 3

In the above embodiments, coolants are discharged to outside of the rotor 4 from both end sides in the axial direction Y of the first channel 83A and the second channel 83B, whereas in the present embodiment 3, a case where the coolant is discharged toward the outer side X1 in the radial direction X from the outer-circumferential surface of the rotor 4 toward the stator 5 side, and a case where a plurality of the first channels 83A and a plurality of the second channels 83B are formed, will be described.

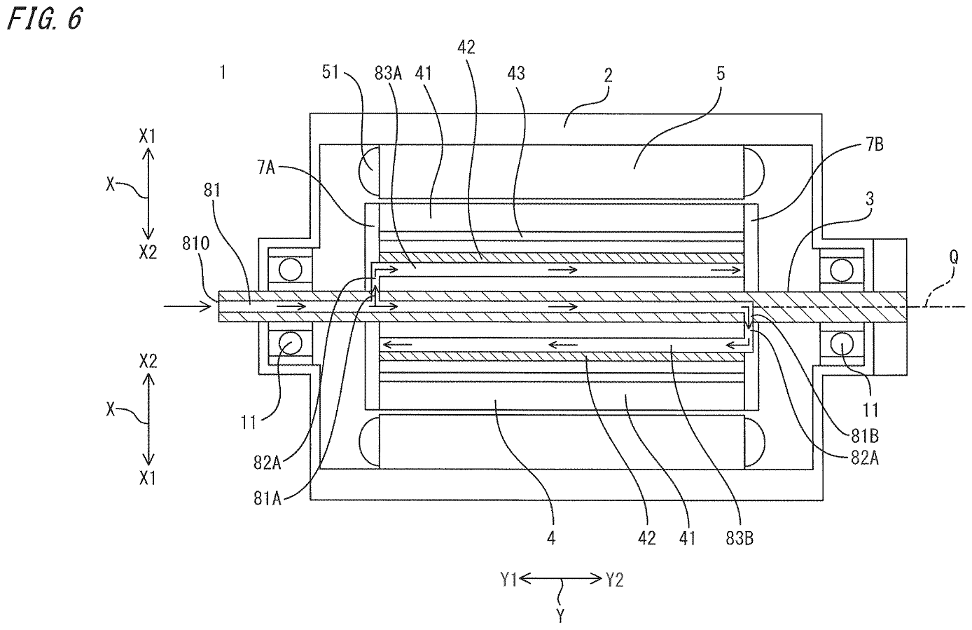

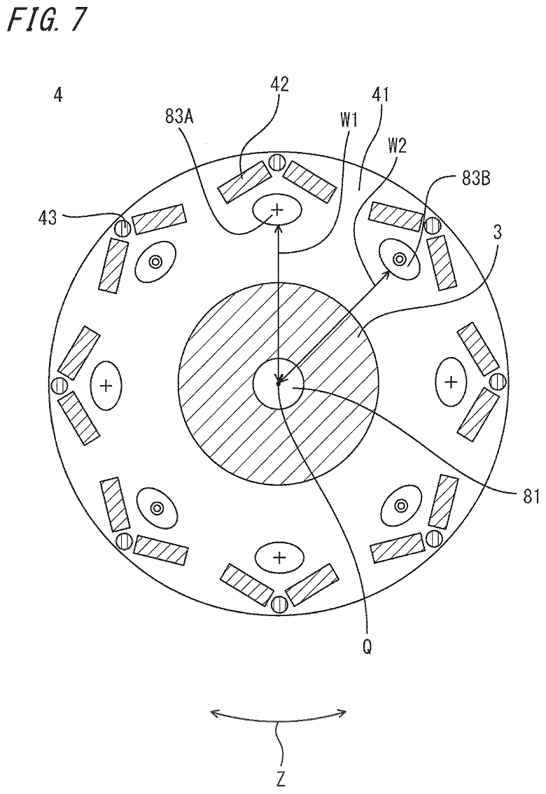

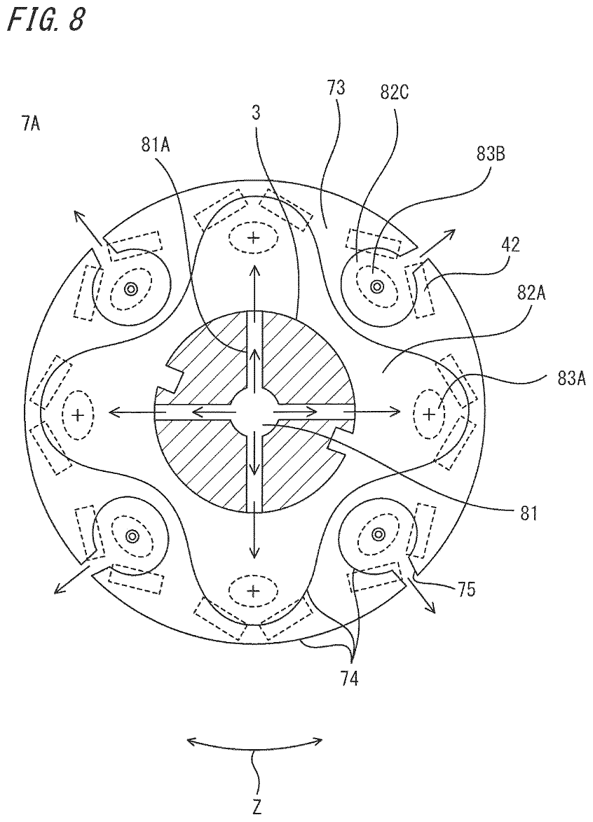

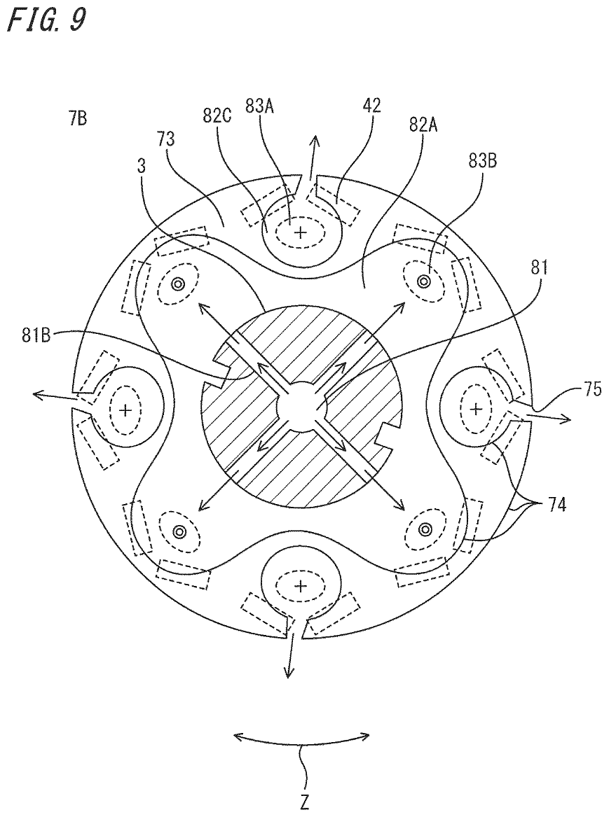

FIG. 6 is a sectional view showing a configuration of a rotary electric machine according to embodiment 3. FIG. 7 is a plan view showing the positional relationship among channels, magnets, and flux barriers in the rotor of the rotary electric machine shown in FIG. 6. FIG. 8 is a plan view showing the relationship between channels and the configuration of the end plate on the one-end side in the axial direction of the rotary electric machine shown in FIG. 6. FIG. 9 is a plan view showing the relationship between channels and the configuration of the end plate on the other-end side in the axial direction of the rotary electric machine shown in FIG. 6.

The same parts as in the above embodiments are denoted by the same reference characters and description thereof is omitted. In FIGS. 7 to 9, parts indicated by “+” are parts where the first channels 83A are formed, and parts indicated by “⊚” are parts where the second channels 83B are formed. Indications of “+” and “⊚” in the drawings are the same also in the other embodiments and therefore description thereof is omitted as appropriate. In FIG. 8, the coolant in the first channel 83A indicated by “+” flows from the front side to the back side of the drawing sheet, and the coolant in the second channel 83B indicated by “⊚” flows in the opposite direction from the back side to the front side of the drawing sheet. In FIG. 9, the coolant in the first channel 83A indicated by “+” flows from the back side to the front side of the drawing sheet, and the coolant in the second channel 83B indicated by “⊚” flows in the opposite direction from the front side to the back side of the drawing sheet.

As shown in FIG. 7, a plurality of the first channels 83A and a plurality of the second channels 83B are formed. A distance W1 from the first channel 83A to the center axis Q of the rotor 4 and a distance W2 from the second channel 83B to the center axis Q of the rotor 4 are the same. The first channels 83A and the second channels 83B are arranged alternately in the circumferential direction Z. The sectional areas of the cross-sections of the first channel 83A and the second channel 83B along the direction perpendicular to the axial direction Y are the same.

In the shown example, the first channels 83A are formed at substantially equal intervals with a pitch of 90° in the circumferential direction Z, and the second channels 83B are also formed at substantially equal intervals with a pitch of 90° in the circumferential direction Z. However, without limitation thereto, for example, the pitch of the substantially equal intervals may be 120°, 72°, 60°, 45°, or 36°. Instead of the equal-interval pitch, an inequal-interval pitch may be adopted and the formation positions can be changed as appropriate in accordance with the configuration of the rotor 4.

As shown in FIG. 8, the end plate 7A on the one-end side Y1 in the axial direction Y has a separation wall 74 and a hole 75. The end plate 7A and the end surface on the one-end side Y1 in the axial direction Y of the rotor 4 together form the end channel 82A which regulates flow of the coolant and connects the first channel 83A and the first communication channel 81A, and an ejection channel 82C connected to the second channel 83B and leading to the hole 75 penetrating toward the outer side X1 in the radial direction X of the rotor 4. A part 73 not serving as the channels 82A and 82C is formed. The ejection channel 82C is formed so as to have a channel sectional area that becomes smaller toward the outer side X1 from the inner side X2 in the radial direction X of the rotor 4. This is for increasing the flow speed of the coolant blown out from the ejection channel 82C as described later.

As shown in FIG. 9, the end plate 7B on the other-end side Y2 in the axial direction Y has a separation wall 74 and a hole 75. The end plate 7B and the end surface on the other-end side Y2 in the axial direction Y of the rotor 4 together form the end channel 82A which regulates flow of the coolant and connects the second channel 83B and the second communication channel 81B, and an ejection channel 82C connected to the second channel 83B and leading to the hole 75 penetrating toward the outer side X1 in the radial direction X of the rotor 4. A part 73 not serving as the channels 82A and 82C is formed.

In the shown example, the formation positions of the end channels 82A and the ejection channels 82C are substantially uniform at a pitch of approximately 90° in the circumferential direction Z so as to correspond to the formation positions of the first channels 83A and the second channels 83B. However, without limitation thereto, the end channels 82A and the ejection channels 82C may be formed as appropriate in accordance with the formation positions of the first channel 83A and the second channel 83. The shapes of the end channels 82A are not limited to the shapes shown in FIGS. 8 and 9. The end channels 82A can be formed in the same manner, using a substantially straight shape, an arc shape, or a spiral shape, for example.

At the end plates 7A and 7B, seals may be provided for preventing the coolant from leaking through parts other than the ejection channels 82C. Since the channels 82A and 82C are formed by the separation wall 74 and the hole 75, the end plates 7A and 7B have a hollow structure, leading to weight reduction. As shown in FIGS. 8 and 9, the end plates 7A and 7B are formed in the same shape.

The end plates 7A and 7B having the same shape are placed as appropriate with their placement angles in the circumferential direction Z changed as shown in FIGS. 8 and 9, whereby the channels 82A and 82C can be formed. Thus, manufacturing cost can be reduced. In FIGS. 8 and 9, the ejection channel 82C is formed in an axial-symmetric shape. However, the shape of the ejection channel 82C is not limited thereto and may be a non-axial-symmetric shape. The direction of the ejection hole of the ejection channel 82C is along substantially the radial direction X toward the outer side X1 in the radial direction X. However, the direction of the ejection hole of the ejection channel 82C is not limited thereto and may be tilted toward the rotation direction or the opposite rotation direction, for example.

Next, flow of the coolant in the rotary electric machine 1 of embodiment 3 configured as described above will be described. In FIGS. 6, 8, and 9, flow of the coolant is indicated by arrows. Description of the same parts as in the above embodiments is omitted as appropriate. As in the above embodiments, the coolant is introduced from the inlet 810 of the in-shaft channel 81, and a part of the coolant is supplied into the first channel 83A via the first communication channel 81A of the in-shaft channel 81 and the end channel 82A.

The coolant that has reached the other-end side Y2 from the one-end side Y1 in the axial direction Y of the first channel 83A is blown out by centrifugal force of the rotor 4 toward the outer side X1 in the radial direction X of the rotor 4 from the ejection channel 82C of the end plate 7B, so as to be discharged. At this part, a coil end which is a part where heat is most generated in the coil 51 is located, and therefore the coolant blown out by centrifugal force of the rotor 4 is blown on the coil end of the coil 51, which is thus cooled.

Another part of the coolant flows into the second communication channel 81B on the other-end side Y2 in the axial direction Y of the in-shaft channel 81, so as to be supplied into the second channel 83B via the end channel 82A. The coolant that has reached the one-end side Y1 from the other-end side Y2 in the axial direction Y of the second channel 83B is blown out by centrifugal force of the rotor 4 toward the outer side X1 in the radial direction X of the rotor 4 from the ejection channel 82C of the end plate 7A, so as to be discharged. At this part, the coil end of the coil 51 of the stator 5 is located, and therefore the coolant blown out by centrifugal force of the rotor 4 is blown on the coil end of the coil 51, which is thus cooled.

The end in the axial direction Y of the magnet 42 and the end in the axial direction Y of the rotor core 41 located in contact with or at a coolable position close to the channels 82A and 82C of the end plate 7A or the end plate 7B, are cooled by the coolants flowing through the channels 82A and 82C.

As shown in FIG. 7, the first channels 83A and the second channels 83B are arranged in an annular shape in the circumferential direction Z at the end surface of the rotor 4, whereby the magnets 42 and the rotor core 41 therearound can be more efficiently cooled. Since not only the rotor 4 but also the coil end of the coil 52 can be cooled, it becomes possible to efficiently cool the stator 5. Since the first channels 83A and the second channels 83B are arranged alternately in the circumferential direction Z, the formation positions of the ejection channels 82C are arranged equally in the circumferential direction Z on both of the one-end side Y1 and the other-end side Y2 in the axial direction Y.

Therefore, on both of the one-end side Y1 and the other-end side Y2 in the axial direction Y, the coolants are discharged uniformly in the circumferential direction Z. Particularly, even when the rotational speed of the rotor 4 is zero, i.e., the positions in the circumferential direction Z of the ejection channels 82C are unlikely to move through rotation, the coolants are ejected to the coil ends of the stator 5 from the ejection channels 82C arranged uniformly in the circumferential direction Z. Thus, the coil ends of the stator 5 can be equally cooled, whereby the temperature distribution in the circumferential direction Z is uniformed and the cooling performance can be improved.

In order to efficiently perform cooling even when the rotor 4 rotates in the opposite rotation direction, the ejection channels 82C may be formed such that at least one of the ejection channels 82C has a different ejection direction. For example, at least one of the ejection channels 82C may be set such that the angle of the ejection direction of the ejection channel 82C with respect to the direction of a tangent to the outer circumference is different.

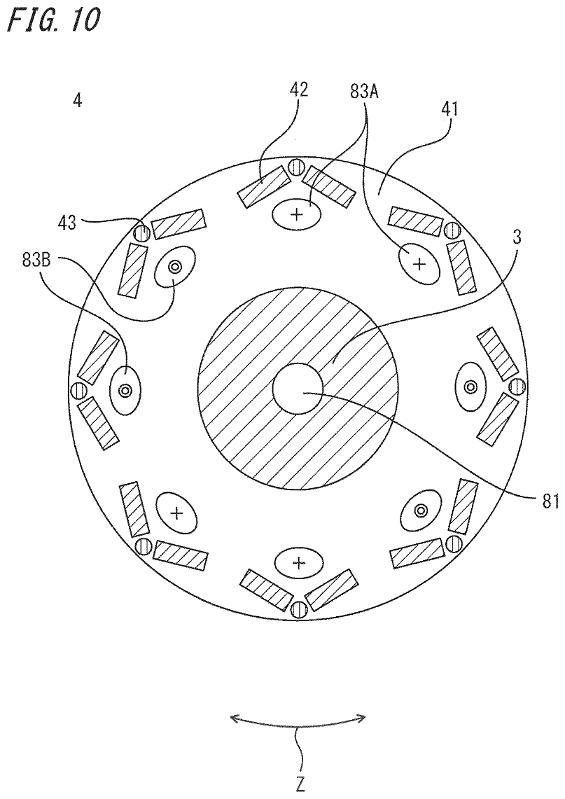

In the above embodiment 3, as shown in FIG. 7, the first channels 83A and the second channels 83B are arranged one by one alternately in the circumferential direction Z. However, without limitation thereto, for example, as shown in FIG. 10, sets of plural, e.g., two, first channels 83A, and sets of plural, e.g., two, second channels 83B, may be arranged alternately in the circumferential direction Z.

The rotary electric machine of embodiment 3 configured as described above provides the same effects as in the above embodiments, and in addition,
an ejection channel connected to at least one of the first channel or the second channel and extending toward an outer side in a radial direction of the rotor so as to be connected to outside, is provided on both end sides in the axial direction of the rotor.

Thus, the coolant is ejected to the stator, whereby the stator can also be cooled.

In the rotary electric machine of embodiment 3 configured as described above, end plates are respectively provided on the one-end side and the other-end side in the axial direction of the rotor, the first channel and the second channel are formed to penetrate through the rotor in the axial direction, the end plates have separation walls and holes, and flow of the coolant is regulated between each end plate and an end surface in the axial direction of the rotor.

Thus, flow of the coolant can be regulated toward each channel and outside, with a simple configuration.

In the rotary electric machine of the above embodiment 3, the end plates on the one-end side and the other-end side in the axial direction are formed in the same shape, the end plates on the one-end side and the other-end side in the axial direction are placed with their placement angles in a circumferential direction changed, one of the end plates, and the end surface on the one-end side in the axial direction of the rotor, together form an end channel connecting the first communication channel and the first channel, and the other end plate, and the end surface on the other-end side in the axial direction of the rotor, together form an end channel connecting the second communication channel and the second channel.

Thus, the end plates at both ends in the axial direction can be formed in the same shape, whereby working cost can be reduced.

In the rotary electric machine of the above embodiment 3, a plurality of the first channels and a plurality of the second channels are formed, and formation positions of the first channels and the second channels are such positions that distances thereof from a center axis of rotation of the rotor are the same and the first channels and the second channels are formed alternately in a circumferential direction.

Thus, the temperature distribution in the circumferential direction of the rotor can be further uniformed.

### Embodiment 4

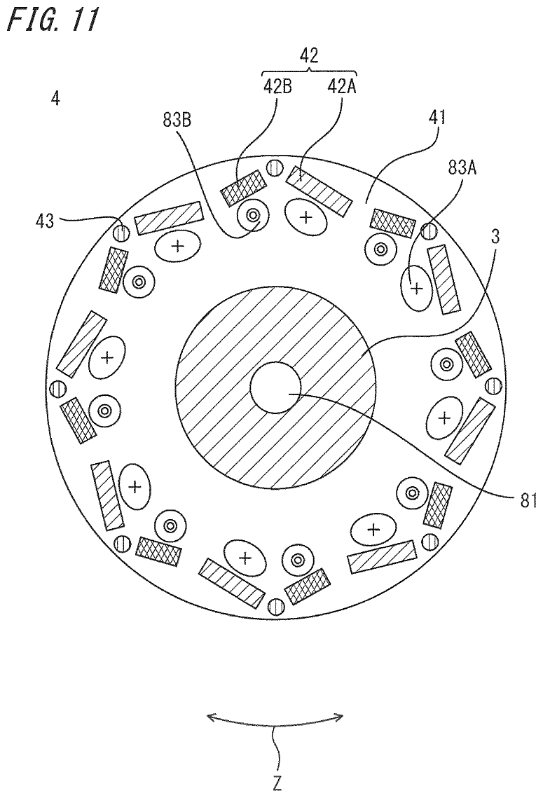

In the above embodiments, difference between heat transfer capabilities (hereinafter, referred to as cooling capabilities) of the first channel 83A and the second channel 83B to coolants, and arrangement positions based thereon, are not particularly limited. In the present embodiment 4, these matters will be described. FIG. 11 is a plan view showing a configuration of a rotor of a rotary electric machine according to embodiment 4. In the drawings, the same parts as in the above embodiments are denoted by the same reference characters and description thereof is omitted.

In the present embodiment 4, the sectional area of the cross-section of the first channel 83A along the direction perpendicular to the axial direction Y is larger than the sectional area of the cross-section of the second channel 83B along the direction perpendicular to the axial direction Y. Thus, the flow volume of the coolant flowing through the first channel 83A becomes greater than the flow volume of the coolant flowing through the second channel 83B. Therefore, the cooling capability of the first channel 83A is greater than the cooling capability of the second channel 83B. The magnets 42 include magnets 42A and 42B having different sizes and arranged alternately in the circumferential direction Z. The size of the magnet 42A is larger than the size of the magnet 42B. Therefore, the heat-generation amount of the magnet 42A is larger than the heat-generation amount of the magnet 42B. The first channel 83A is located close to the magnet 42A having a large heat-generation amount, and the second channel 83B is located close to the magnet 42B having a small heat-generation amount.

In the rotary electric machine of embodiment 4 configured as described above, the first channels 83A and the second channels 83B of which the cross-sections along the direction perpendicular to the axial direction Y have different sectional areas are arranged as appropriate in accordance with the heat-generation amounts of the magnets 42A and 42B, whereby the rotor 4 can be more efficiently cooled and the temperature distribution in the rotor 4 can be further uniformed. Thus, the maximum temperature of the rotor 4 can be further reduced.

In the above embodiment 4, the sectional area of the cross-section of the first channel 83A along the direction perpendicular to the axial direction Y is larger than the sectional area of the cross-section of the second channel 83B along the direction perpendicular to the axial direction Y, to obtain difference between the cooling capabilities. However, without limitation thereto, for example, fine protrusion shapes may be provided on the surface of the first channel 83A so as to increase the surface area of the first channel 83A, thus improving the cooling capability.

A surface treatment may be performed less on the first channel 83A than on the second channel 83B so that the first channel 83A has a smaller thermal resistance resulting from the surface treatment so as to have an increased cooling capability. The first channel 83A may have therein a protrusion shape so as to influence flow of the coolant, so that the flow in the channel becomes turbulent, thus increasing the cooling capability. With this configuration, parts where the heat-generation amounts are large can be efficiently cooled, whereby the temperature distribution in the rotor 4 can be further uniformed.

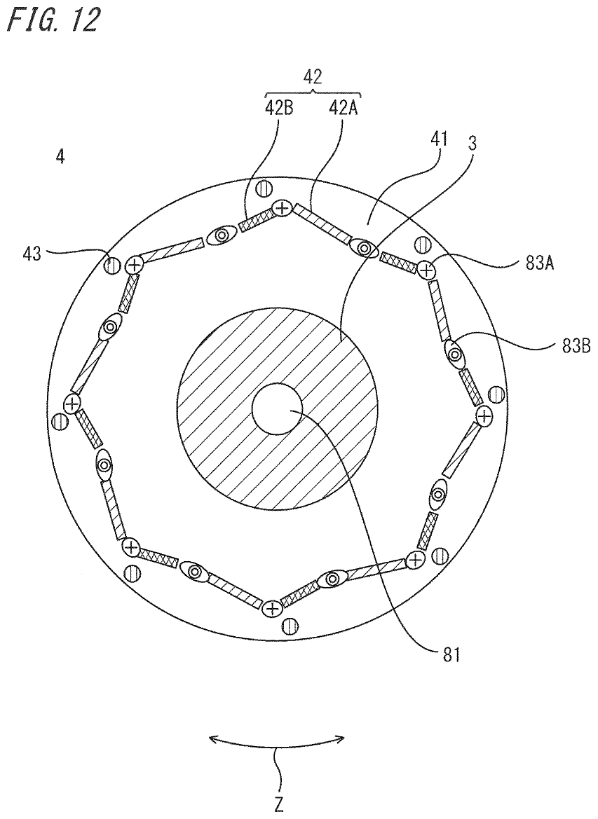

As shown in FIG. 12, the first channels 83A and the second channels 83B may be formed between the magnets 42 in the circumferential direction Z.

The rotary electric machine of embodiment 4 configured as described above provides the same effects as in the above embodiments, and in addition,
a formation position of the first channel is a position where a heat-generation amount is larger in a heat generation distribution of the rotor than a formation position of the second channel, and a heat-transfer capability of the first channel to the coolant is greater than a heat-transfer capability of the second channel to the coolant.

Therefore, parts of the rotor where the heat-generation amounts are large can be efficiently cooled, whereby cooling efficiency for the rotor is further improved and the temperature distribution in the rotor can be further uniformed. As a result, the maximum temperature of the rotary electric machine can be further reduced. Thus, further size reduction and further output increase in the entire rotary electric machine can be achieved.

### Embodiment 5

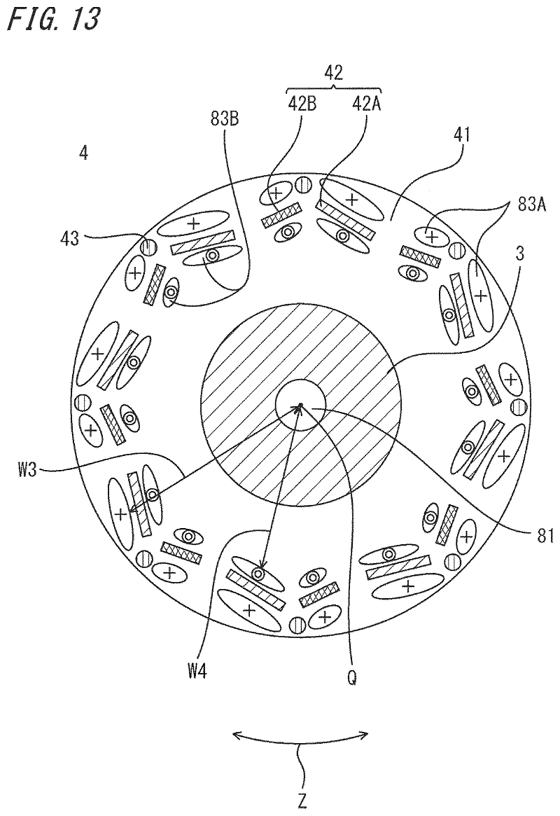

In the above embodiments, the first channels 83A and the second channels 83B are formed on the same circle (at equal distances from the center axis Q). However, without limitation thereto, cases where the first channels 83A and the second channels 83B are formed on different circles (at different distances from the center axis Q) will be described. FIGS. 13, 14, and 15 are plan views showing configurations of a rotor of a rotary electric machine according to embodiment 5. Here, examples in which cooling performance of the first channel 83A is higher than cooling performance of the second channel 83B are shown. In the drawings, the same parts as in the above embodiments are denoted by the same reference characters and description thereof is omitted.

As shown in FIG. 13, the first channel 83A and the second channel 83B are formed at such positions that a distance W3 from the first channel 83A to the center axis Q of the rotor 4 is longer than a distance W4 from the second channel 83B to the center axis Q of the rotor 4. The first channel 83A and the second channel 83B are formed with the magnet 42 interposed therebetween in the radial direction X That is, the formation position of the first channel 83A is on the outer side X1 in the radial direction X of the rotor 4 relative to the formation position of the second channel 83B. With this configuration, heat generated due to eddy loss occurring in a large amount at the outer circumference of the rotor 4 can be actively cooled, whereby cooling performance at the outer circumference of the rotor 4 can be further improved.

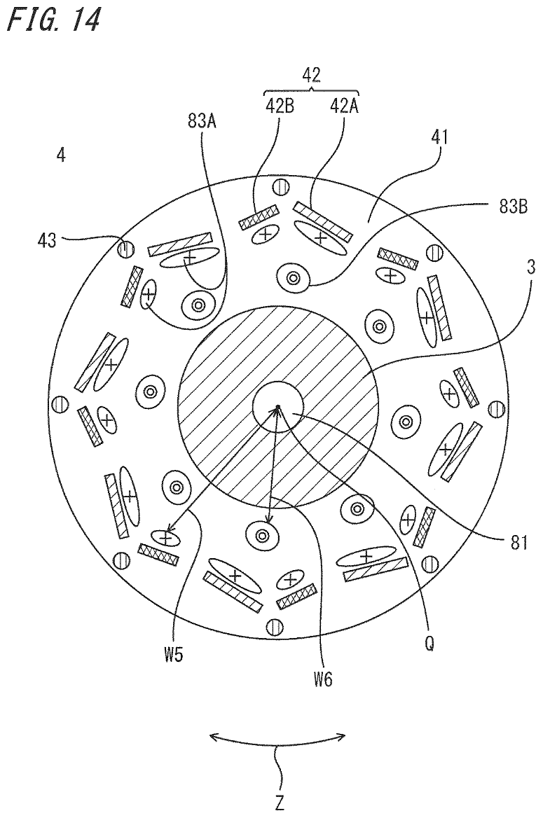

In another example, as shown in FIG. 14, the first channel 83A and the second channel 83B are formed at such positions that a distance W5 from the first channel 83A to the center axis Q of the rotor 4 is longer than a distance W6 from the second channel 83B to the center axis Q of the rotor 4. That is, the formation position of the first channel 83A is on the outer side X1 in the radial direction X of the rotor 4 relative to the formation position of the second channel 83B.

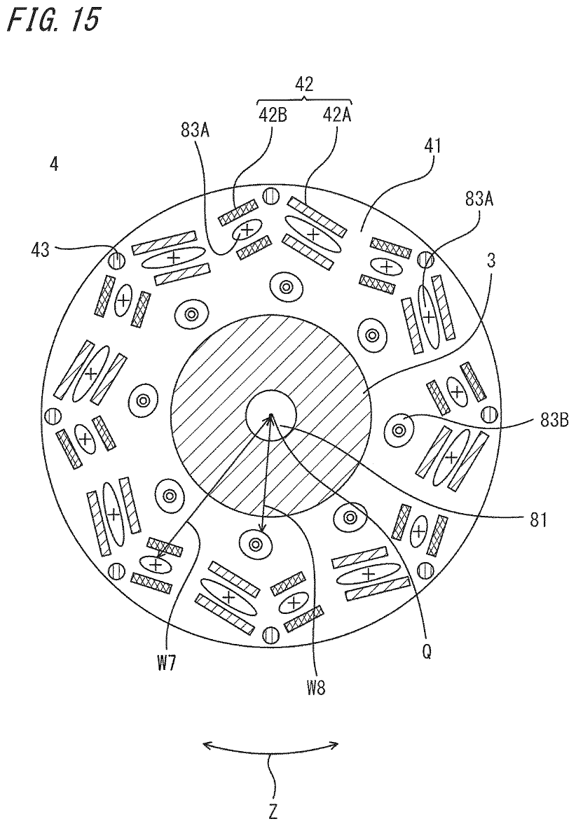

In another example, as shown in FIG. 15, the first channel 83A and the second channel 83B are formed at such positions that a distance W7 from the first channel 83A to the center axis Q of the rotor 4 is longer than a distance W8 from the second channel 83B to the center axis Q of the rotor 4. That is, the formation position of the first channel 83A is on the outer side X1 in the radial direction X of the rotor 4 relative to the formation position of the second channel 83B.

Particularly, as shown in FIGS. 14 and 15, the second channel 83B is located close to the rotary shaft 3, i.e., when the rotary electric machine 1 is in a non-energized state or a maximum-torque state, the magnetic flux density at the formation position of the second channel 83B is smaller than at the formation position of the first channel 83A, and is not greater than 0.1 [T]. In this way, the second channel 83B having lower cooling performance than the first channel 83A is located on the inner side X2 in the radial direction X as shown in FIGS. 14 and 15, so that interference with the magnetic circuit is reduced. Thus, it is possible to improve cooling performance without reducing electromagnetic performance of the rotary electric machine 1.

The rotary electric machine of embodiment 5 configured as described above provides the same effects as in the above embodiments, and in addition,
the formation position of the first channel is on an outer side in a radial direction of the rotor relative to the formation position of the second channel.

Thus, the outer side in the radial direction where eddy loss of the rotor is great can be efficiently cooled,

The rotary electric machine of embodiment 5 configured as described above provides the same effects as in the above embodiments, and in addition,
the formation positions of the first channel and the second channel are such positions that a distance between the first channel and the magnet is shorter than a distance between the second channel and the magnet.

Thus, magnets which are heat generation sources in the rotor and for which the temperature is to be reduced can be efficiently cooled.

In the rotary electric machine of embodiment 5 configured as described above, the formation positions of the first channel and the second channel are such positions that, when the rotary electric machine is in a non-energized state or a maximum-torque state, a magnetic flux density at the second channel is smaller than a magnetic flux density at the first channel.

Thus, the second channel having a lower cooling capability than the first channel is located on the inner side in the radial direction, whereby interference with the magnetic circuit can be reduced and cooling efficiency for the rotor can be improved without reducing electromagnetic performance of the rotary electric machine.

### Embodiment 6

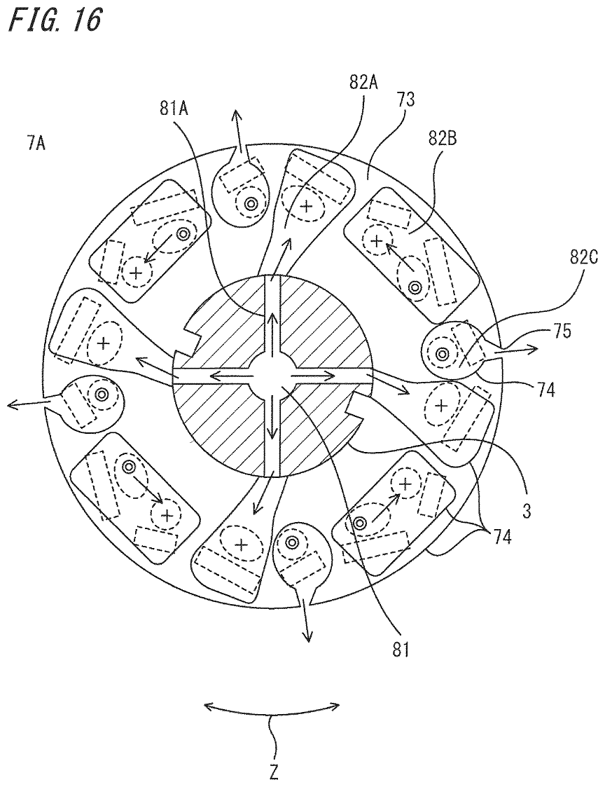

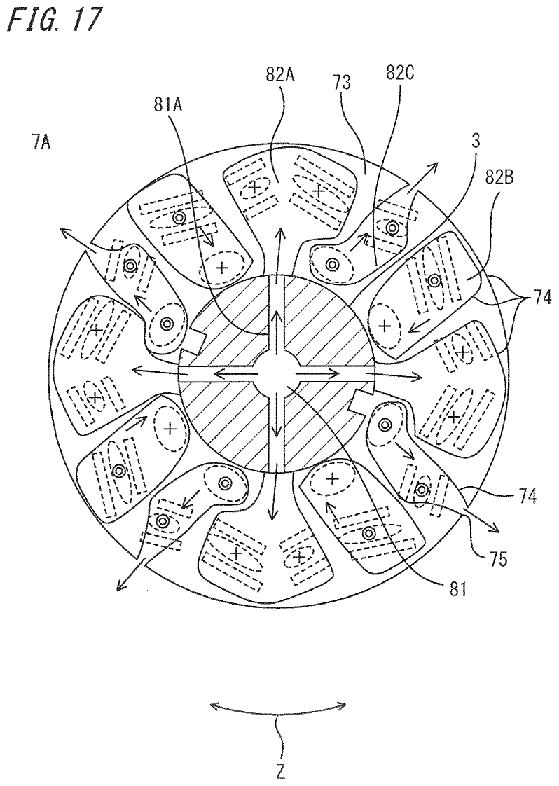

In the above embodiments, the first channel 83A and the second channel 83B do not communicate with each other between each end plate 7A, 7B and the end surface in the axial direction Y of the rotor 4. However, without limitation thereto, in the present embodiment 6, an example in which the first channel and the second channel communicate with each other will be described. FIGS. 16 and 17 are plan views showing configurations of end plates of a rotor of a rotary electric machine according to embodiment 6. In the drawings, the same parts as in the above embodiments are denoted by the same reference characters and description thereof is omitted.

As shown in FIG. 16, the end plate 7A and the end surface on the one-end side Y1 in the axial direction Y of the rotor 4 together form a third communication channel 82B which extends in the circumferential direction Z and through which the first channel 83A and the second channel 83B communicate with each other. The end plate 7B is also formed in the same manner together with the end surface on the other-end side Y2 in the axial direction Y of the rotor 4.

In another example, as shown in FIG. 17, the end plate 7A and the end surface on the one-end side Y1 in the axial direction Y of the rotor 4 together form a third communication channel 82B which extends in the radial direction X and through which the first channel 83A and the second channel 83B communicate with each other. The end plate 7B is also formed in the same manner together with the end surface on the other-end side Y2 in the axial direction Y of the rotor 4.

In FIGS. 16 and 17, the coolant in the first channel 83A indicated by “+” flows from the front side to the back side of the drawing sheet, and the coolant in the second channel 83B indicated by “⊚” flows in the opposite direction from the back side to the front side of the drawing sheet.

As shown in the drawings, the coolant may pass through each of the first channel 83A and the second channel 83B at least once or may pass through the first channel 83A and the second channel 83B a plurality of times. The coolant finally passes through the ejection channel 82C, to be discharged to outside of the rotor 4. The shape of the third communication channel 82B is not limited to the shapes shown in FIGS. 16 and 17. The third communication channel 82B may be formed in the same manner, using a substantially straight shape, an arc shape, or a spiral shape, for example.

The rotary electric machine of embodiment 6 configured as described above provides the same effects as in the above embodiments, and in addition,
each end plate has a third communication channel through which the first channel and the second channel communicate with each other.

Thus, communication between the first channel and the second channel can be made at the end in the axial direction of the rotor.

### Embodiment 7

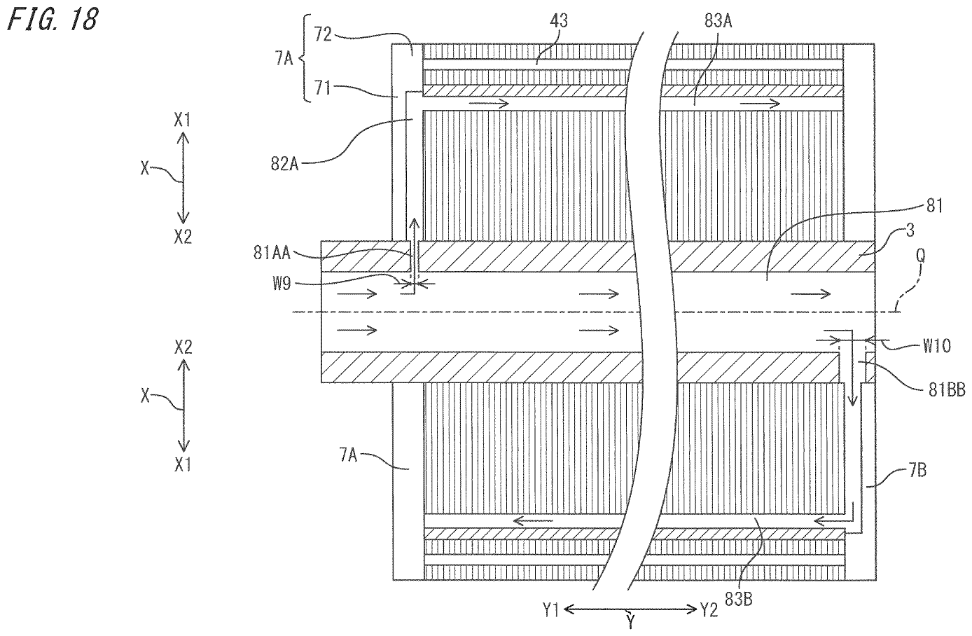

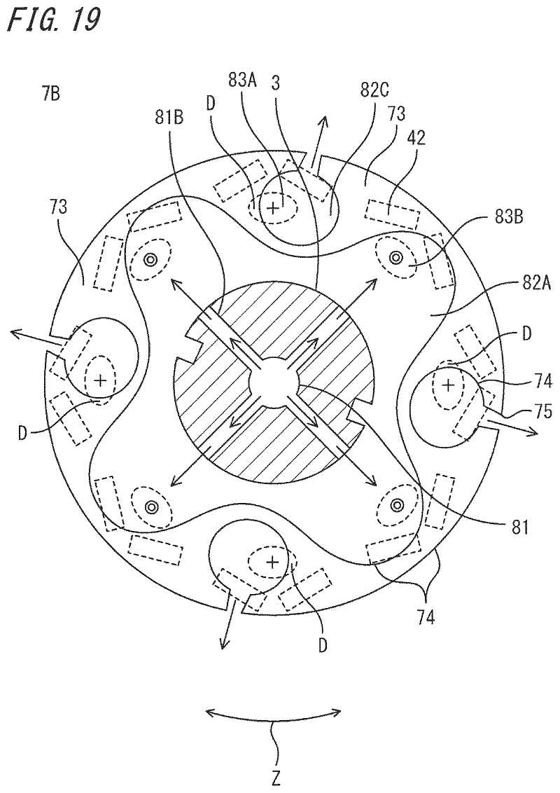

In the present embodiment 7, a case where the flow-volume distribution of the coolant between the first channel 83A and the second channel 83B is uniformed will be described. FIG. 18 is a sectional view showing a configuration of a rotary electric machine according to embodiment 7. FIG. 19 is a plan view showing a configuration of an end plate on the other-end side in the axial direction shown in FIG. 18. In the drawings, the same parts as in the above embodiments are denoted by the same reference characters and description thereof is omitted.

As shown in FIG. 18, a width W9 in the axial direction Y of a first communication channel 81AA is smaller than a width W10 in the axial direction Y of a second communication channel 81BB so that the channel sectional area of the first communication channel 81AA is smaller than the channel sectional area of the second communication channel 81BB. The end plate 7A on the one-end side Y1 in the axial direction Y is provided as shown in FIG. 8. The end plate 7B on the other-end side Y2 in the axial direction Y is provided as shown in FIG. 19.

As shown in FIG. 19, the end plate 7B is placed so as to cover a part of the exit of the first channel 83A by a part 73 not serving as the channels 82A and 82C (covers a part D shown in FIG. 19), thus suppressing outflow from the first channel 83A to the ejection channel 82C. In FIG. 19, the coolant in the first channel 83A indicated by “+” flows from the back side to the front side of the drawing sheet, and the coolant in the second channel 83B indicated by “⊚” flows in the opposite direction from the front side to the back side of the drawing sheet.

With this configuration, pressure loss of the coolant that passes from the first communication channel 81AA to the first channel 83A, flows through the first channel 83A from the one-end side Y1 to the other-end side Y2 in the axial direction Y, and then is ejected to outside from the ejection channel 82C of the end plate 7B, can be made close to pressure loss of the coolant that passes from the second communication channel 81BB to the second channel 83B, flows through the second channel 83B from the other-end side Y2 to the one-end side Y1 in the axial direction Y, and then is ejected to outside from the ejection channel 82C of the end plate 7A, whereby the flow-volume distribution of the coolant between the first channel 83A and the second channel 83B can be equalized and thus the temperature distribution in the rotor 4 can be uniformed.

The rotary electric machine of embodiment 7 configured as described above provides the same effects as in the above embodiments, and in addition,
the in-shaft channel has an inlet for the coolant, on the one-end side in the axial direction of the rotary shaft, a channel sectional area of the first communication channel is smaller than a channel sectional area of the second communication channel, each end plate, together with the end surface in the axial direction of the rotor, forms an ejection channel extending toward an outer side in a radial direction of the rotor and connected to outside, the end plate on the other-end side in the axial direction is placed so as to cover a part of the first channel by a periphery of the ejection channel, and the end plate on the one-end side in the axial direction is placed so as not to cover the second channel by a periphery of the ejection channel.

Thus, pressure losses in the first channel and the second channel can be uniformed and the flow-volume distribution therebetween is equalized, whereby the temperature distribution in the rotor can be uniformed.

### Embodiment 8

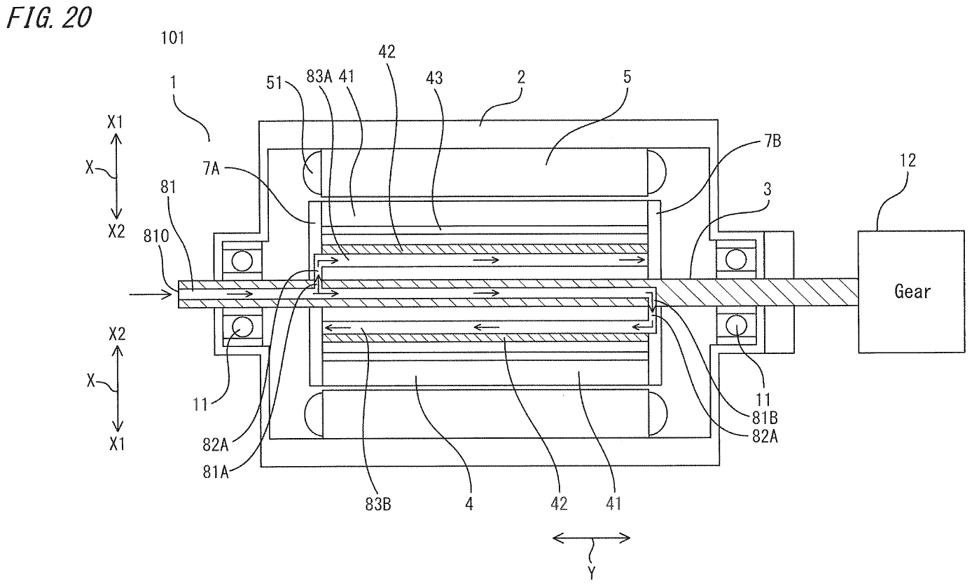

FIG. 20 shows a configuration of a rotary electric machine unit according to embodiment 8. In the drawings, the same parts as in the above embodiments are denoted by the same reference characters and description thereof is omitted. As shown in FIG. 20, a rotary electric machine unit 101 includes a gear 12 which is provided on the other-end side Y2 in the axial direction Y opposite to the inlet 810 of the in-shaft channel 81 and is connected to the rotary shaft 3 serving as an output shaft of the rotary electric machine 1.

When the rotary electric machine unit 101 is configured as described above and the gear 12 is provided at the above position, arrangement and assembly can be performed irrespective of the channels for the coolant, and the structure can be simplified.

The rotary electric machine of embodiment 8 configured as described above provides the same effects as in the above embodiments, and in addition,
in a rotary electric machine unit, a gear is connected to the rotary shaft of the rotary electric machine described above, and the gear is provided on the other-end side in the axial direction opposite to the one-end side in the axial direction where the coolant is introduced into the in-shaft channel.

Thus, assembly and the structure of the rotary electric machine unit can be simplified, without using a complicated configuration.

Flow of the coolant is not limited to those shown in the above embodiments. For example, the coolant may flow through channels in orders shown below.

In example 1, the coolant passes through the first communication channel 81A and the end channel 82A from the in-shaft channel 81 and flows through the first channel 83A. Then, the coolant passes through the third communication channel 82B and flows in series through the second channel 83B, to be discharged from the ejection channel 82C. Meanwhile, the coolant passes from the in-shaft channel 81 through the second communication channel 81B and the end channel 82A and flows through the second channel 83B. Then, the coolant passes through the third communication channel 82B and flows in series through the first channel 83A, to be discharged from the ejection channel 82C.

In example 2, the coolant passes through the first communication channel 81A and the end channel 82A from the in-shaft channel 81 and flows through the first channel 83A. Then, the coolant branches into the third communication channel 82B and the ejection channel 82C, and a part of the coolant flows out from the ejection channel 82C. The coolant flowing into the third communication channel 82B flows through the second channel 83B and is discharged from the ejection channel 82C.

In example 3, the coolant passes through the first communication channel 81A and the end channel 82A from the in-shaft channel 81 and flows through the first channel 83A. Then, the coolant branches into the third communication channel 82B and the ejection channel 82C, and a part of the coolant flows out from the ejection channel 82C. The coolant flowing into the third communication channel 82B flows through the second channel 83B and is discharged from the ejection channel 82C. Meanwhile, the coolant passes through the second communication channel 81B and the end channel 82A from the in-shaft channel 81 and flows through the second channel 83B, to be discharged from the ejection channel 82C.

The above flows of the coolant are merely examples. As long as directions of the coolant flowing in the axial direction Y are opposite to each other between the first channel 83A and the second channel 83B, any other configuration may be adopted and the same effects as in the above embodiments can be provided.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure.

For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 rotary electric machine
100 fan
101 rotary electric machine unit
11 bearing
12 gear
2 housing
3 rotary shaft
4 rotor
41 rotor core
42 magnet
43 flux barrier
5 stator
51 coil
7A end plate
7B end plate
71 annular-plate portion
71A opening
73 part not serving as channel
74 separation wall
75 hole
77 hole
81 in-shaft channel
810 inlet
81A first communication channel
81AA first communication channel
81B second communication channel
81BB second communication channel
82A end channel
82B third communication channel
82C ejection channel
83A first channel
83B second channel
Q center axis
W1 distance
W2 distance
W3 distance
W4 distance
W5 distance
W6 distance
W7 distance
W8 distance
W9 width
W10 width
X radial direction
X1 outer side
X2 inner side
Y axial direction
Y1 one-end side
Y2 other-end side
Z circumferential direction

1. A rotary electric machine comprising:
a rotary shaft;
a rotor fixed to an outer circumference of the rotary shaft and having a magnet; and
a stator provided on an outer-circumferential side of the rotor, wherein
the magnet is formed to extend from a one-end side to an other-end side in an axial direction of the rotor,
the rotor includes a first channel and a second channel which extend from the one-end side to the other-end side in the axial direction of the rotor and through which a coolant flows,
at least one of the first channel or the second channel is formed along the magnet, and
directions of the coolant flowing in the axial direction are opposite to each other between the first channel and the second channel.

2. The rotary electric machine according to claim 1, wherein
the rotary shaft includes
an in-shaft channel through which the coolant flows and which extends at a position corresponding to a range from the one-end side to the other-end side in the axial direction of the rotor in the rotary shaft,
a first communication channel communicating from a one-end side in the axial direction of the in-shaft channel to the first channel, and
a second communication channel communicating from the other-end side in the axial direction of the in-shaft channel to the second channel.

3. The rotary electric machine according to claim 2, wherein
an ejection channel connected to at least one of the first channel or the second channel and extending toward an outer side in a radial direction of the rotor so as to be connected to outside, is provided on both end sides in the axial direction of the rotor.

4. The rotary electric machine according to claim 2, wherein
end plates are respectively provided on the one-end side and the other-end side in the axial direction of the rotor,
the first channel and the second channel are formed to penetrate through the rotor in the axial direction,
the end plates have separation walls and holes, and
flow of the coolant is regulated between each end plate and an end surface in the axial direction of the rotor.

5. The rotary electric machine according to claim 4, wherein
the end plates on the one-end side and the other-end side in the axial direction are formed in the same shape,
the end plates on the one-end side and the other-end side in the axial direction are placed with their placement angles in a circumferential direction changed,
one of the end plates, and the end surface on the one-end side in the axial direction of the rotor, together form an end channel connecting the first communication channel and the first channel, and
the other end plate, and the end surface on the other-end side in the axial direction of the rotor, together form an end channel connecting the second communication channel and the second channel.

6. The rotary electric machine according to claim 4, wherein
each end plate, together with the end surface in the axial direction of the rotor, forms a third communication channel through which the first channel and the second channel communicate with each other.

7. The rotary electric machine according to claim 2, wherein
a plurality of the first channels and a plurality of the second channels are formed, and
formation positions of the first channels and the second channels are such positions that distances thereof from a center axis of rotation of the rotor are the same and the first channels and the second channels are formed alternately in a circumferential direction.

8. The rotary electric machine according to claim 5, wherein
the in-shaft channel has an inlet for the coolant, on the one-end side in the axial direction of the rotary shaft,
a channel sectional area of the first communication channel is smaller than a channel sectional area of the second communication channel,
each end plate, together with the end surface in the axial direction of the rotor, forms an ejection channel extending toward an outer side in a radial direction of the rotor and connected to outside,
the end plate on the other-end side in the axial direction is placed so as to cover a part of the first channel by a periphery of the ejection channel, and
the end plate on the one-end side in the axial direction is placed so as not to cover the second channel by a periphery of the ejection channel.

9. The rotary electric machine according to claim 2, wherein
a formation position of the first channel is a position where a heat-generation amount is larger in a heat generation distribution of the rotor than a formation position of the second channel, and
a heat-transfer capability of the first channel to the coolant is greater than a heat-transfer capability of the second channel to the coolant.

10. The rotary electric machine according to claim 9, wherein
the formation position of the first channel is on an outer side in a radial direction of the rotor relative to the formation position of the second channel.

11. The rotary electric machine according to claim 9, wherein
the formation positions of the first channel and the second channel are such positions that a distance between the first channel and the magnet is shorter than a distance between the second channel and the magnet.

12. The rotary electric machine according to claim 9, wherein
the formation positions of the first channel and the second channel are such positions that, when the rotary electric machine is in a non-energized state or a maximum-torque state, a magnetic flux density at the second channel is smaller than a magnetic flux density at the first channel.

13. A rotary electric machine unit in which a gear is connected to the rotary shaft of the rotary electric machine according to claim 2, wherein
the gear is provided on the other-end side in the axial direction opposite to the one-end side in the axial direction where the coolant is introduced into the in-shaft channel.

14. The rotary electric machine according to claim 3, wherein
end plates are respectively provided on the one-end side and the other-end side in the axial direction of the rotor,
the first channel and the second channel are formed to penetrate through the rotor in the axial direction,
the end plates have separation walls and holes, and
flow of the coolant is regulated between each end plate and an end surface in the axial direction of the rotor.

15. The rotary electric machine according to claim 5, wherein
each end plate, together with the end surface in the axial direction of the rotor, forms a third communication channel through which the first channel and the second channel communicate with each other.

16. The rotary electric machine according to claim 3, wherein
a plurality of the first channels and a plurality of the second channels are formed, and
formation positions of the first channels and the second channels are such positions that distances thereof from a center axis of rotation of the rotor are the same and the first channels and the second channels are formed alternately in a circumferential direction.

17. The rotary electric machine
according to claim 4, wherein
a plurality of the first channels and a plurality of the second channels are formed, and
formation positions of the first channels and the second channels are such positions that distances thereof from a center axis of rotation of the rotor are the same and the first channels and the second channels are formed alternately in a circumferential direction.

18. The rotary electric machine
according to claim 5, wherein
a plurality of the first channels and a plurality of the second channels are formed, and
formation positions of the first channels and the second channels are such positions that distances thereof from a center axis of rotation of the rotor are the same and the first channels and the second channels are formed alternately in a circumferential direction.

19. The rotary electric machine
according to claim 6, wherein
a plurality of the first channels and a plurality of the second channels are formed, and
formation positions of the first channels and the second channels are such positions that distances thereof from a center axis of rotation of the rotor are the same and the first channels and the second channels are formed alternately in a circumferential direction.

20. The rotary electric machine
according to claim 3, wherein
a formation position of the first channel is a position where a heat-generation amount is larger in a heat generation distribution of the rotor than a formation position of the second channel, and
a heat-transfer capability of the first channel to the coolant is greater than a heat-transfer capability of the second channel to the coolant.
